(19) United States
(12) Patent Application Publication
(10) Pub. No.: US 2003/0065442 A1
(43) Pub. Date: Apr. 3, 2003

(54) Navigation system and travel coordinator with dynamic traffic data

(76) Inventor: David Sylvester Touney, San Francisco, CA (US)

Correspondence Address: David Touney, Apt 1, 558 21st Ave, San Francisco, CA, 94121, US

(21) Appl. No.: 10/233,899

(22) Filed: Aug. 31, 2002

Related U.S. Application Data
(60) Provisional application No. 60/316,895, filed on Sep. 1, 2001.

(51) Int. Cl. G01C 21/30

(52) U.S. Cl. 701/210; 701/208

(57) ABSTRACT

A system provides personalized traffic information and route planning capabilities to users of the system using existing wireless personal telephone and communication systems that allow for the geo-location of users in the network. This system uses standard geo-location methods and telecommunication equipment to triangulate the position of a user and transfer data between them and the central system. This user information is collected and used to compute real-time system wide model of the street segments in the traffic network. This model can then be used to create individual routing information for any user of the system. This computed travel time information is used to determine the most efficient route for a user and can be transmitted to the user. As a user travels, their location is constantly obtained and their travel route information is updated and relayed to them.

### RELATED APPLICATIONS

This application claims benefit of U.S. provisional patent application Ser. No. 60/316,895, filed Sep. 1, 2001, which is incorporated by reference.

### FIELD OF THE INVENTION

The present invention relates to a system for providing traffic report information, route and travel planning assistance, and navigational assistance to users in the system. More particularly, it relates to a system having a central database in which travel, routing, and travel time information is updated periodically from and to users traveling in the system.

### BACKGROUND OF THE INVENTION

Traffic reports on the radio or television provide useful information to travelers about accidents, heavy traffic, construction, and other conditions which can cause increases in expected travel times. This information is broadcast periodically, but may not be readily available when a person actually needs a report. Additionally, such reports only cover major highways and commuting routes. Often, drivers experience significant delays on routes which are not reported in any traffic reports. Therefore, it would be useful for drivers to be able to obtain accurate traffic reports covering the roads they intend to travel.

In addition to difficulties in providing useful reports, news agencies have difficulty in acquiring relevant traffic information for the roads which they do cover. Often, traffic report information is based upon personal observations provided to a news agency. News agencies have been using helicopters in order to monitor the major highways for significant backups and delays. They also use information provided to them from actual drivers as to delays, traffic conditions and travel times. Such sources cannot provide particularly useful information or objective data as to the likely extent of delays in traffic.

Various attempts have been made to create automated systems for determining traffic information, and to provide more objective estimates of traffic flow. For example, U.S. Pat. No. 5,465,289 discloses a method and apparatus for determining vehicular traffic information using existing cellular telephone technology. Sensors are used to monitor cellular telephone communication information. Data from the cellular communications are extracted and analyzed to determine vehicle locations and travel information. However, this system requires a statistical model for determining location of automobiles within each cell of the cellular system and specialized equipment to capture and determine the approximate geolocation of a person in the system and excludes the use of Global Positioning System (GPS) data to locate users. Also, this system does not provide the support for transferring routing data and information acquired from this system back to the users of the system.

In addition to traffic report information, systems have been and are being developed for providing route planning information and navigational assistance to drivers. One such system is illustrated in U.S. Pat. No. 5,272,638, assigned to Texas Instruments Incorporated. This system includes a digital road map database providing information about road segments, intersections, and travel times for road segments. Information in the database is used to plan routes having minimal travel time from one location to another. More efficient route planning is obtained by using a route hierarchy of local areas around the starting and ending locations, major thoroughfares between local areas, and major freeways for longer travel distances. Preferably, vehicle location information can be determined using satellite systems or some other positioning method. Instructions can then be provided audibly or visually to the driver when turns are necessary in the travel plan. This patent provides suggestions for a process for determining a route based upon the travel destination and the travel times stored in the database. However, the patent does not describe how the information in the database can be obtained. It suggests that dynamic traffic information can be obtained through a traffic interface. A traffic interface may receive digital broadcast over radio sidebands, or from centralized cellular phone systems containing information on traffic obstacles such as accidents and amounts of the resulting delays. However, no suggestion is made as to how such dynamic information is collected or organized for transfer to the system in the vehicle. Therefore, a need exists for a system which provides for collection, organization and dissemination of traffic information which can be used in a route planning and navigation system.

U.S. Pat. No. 5,459,667, assigned to Sumitomo Electric Industries, Ltd., is another example of a vehicle navigation system. The system disclosed in this patent provides for more accurate vehicle location determinations and a capability to determine whether the vehicle is traveling on an optimum route between starting and ending locations. As with the previously-described system, this system uses a database having information relating to street segments and travel times in order to estimate the optimum route. Preferably, the travel information is stored in a CD ROM. Since the information is stored in a CD ROM, it is not easily changeable and cannot be adjusted for changes in travel times resulting from changes in road conditions. Again, this system does not determine how to create the database, to determine travel time, or how to adjust travel time to account for traffic conditions.

The Illinois Department of Transportation is developing a system, called ADVANCE (Advanced Driver and Vehicle Advisory Navigation ConcEpt). The ADVANCE system is described in several articles including “Operation of the ADVANCE Traffic Information Center” by Jeffrey Hochmuth (Jan. 25, 1995) and “ADVANCE-Initial Deployment” by Joseph S. Ligas and Syde Bowott, ITS America, 1995 Annual Conference (March, 1995). A traffic information center collects and organizes traffic data from a variety of sources. These sources include a closed loop traffic signal system, a cellular based motorist call-in system, a motorist assistance system, and emergency dispatch systems. The information is used to create historical databases and a CD ROM of travel data. Each vehicle is provided with a mobile navigation assistant, which provides route planning using both static and dynamic travel time data. Static data are provided by the CD ROM. The mobile navigation system provides route planning and navigational information similar to the systems described above. In addition to static information, the mobile navigation assistance communicates with the traffic information center through a radio frequency communications network to obtain dynamic traffic information data. The dynamic traffic data can be used for more accurate route planning, or for rerouting based upon new information. The ADVANCE system also anticipates using vehicles as traffic probes to provide real time traffic information. The vehicles would transmit data to the traffic information center over the radio frequency communications network on recently traversed streets in the system. The traffic information center would combine this information with the traffic information from other sources in creating its dynamic traffic data. Although the ADVANCE system is still being developed and the descriptions are incomplete, several disadvantages are apparent in the system. Significant additional equipment is needed in the vehicle to operate the system. Much of this equipment is duplicative of functions performed by other equipment already present in many vehicles. The radio communications equipment would need specific frequencies and may interfere with other radio communications. Additionally, no method for combining dynamic data from automobiles with other information relating to potential traffic delays is indicated. The use of additional information may cause distortion of the dynamic traffic data unless the effect of the traffic conditions from the outside sources can be accurately reflected in the travel times used for route planning.

Furthermore, each of the navigation systems described above include only travel times for various street segments. Often, delays are caused by transitions between street segments.

Finally in U.S. Pat. No. 5,933,100, assigned to Mitsubishi Electric Information Technology Center America, Inc., a automobile navigation system is described that is capable of obtaining dynamic traffic data from drivers and sending routing information derived from that data back to the driver. This system as described, still requires equipment that is specific to the automobile and therefore cannot be accessed by a user outside of their vehicle. Additionally, this system does not provide for users of the system that would desire information derived from it, that do not have the specified equipment necessary to access the system.

| | | | |
|---|---|---|---|
| 5220507 | June 1993 | Kirson | 364/449. |
| 5317311 | May 1994 | Martell et al. | 340/905. |
| 5365449 | November 1994 | Kashiwazaki | 340/995. |
| 5371678 | December 1994 | Nomura | 340/995. |
| 5402117 | March 1995 | Zijerhand | 340/905. |
| 5450343 | September 1995 | Yurimoto et al. | 340/995. |
| 5452217 | September 1995 | Kishi et al. | 340/995. |
| 5473324 | December 1995 | Ueno | 340/990. |
| 5523950 | June 1996 | Peterson | 340/905. |
| 5539398 | July 1996 | Hall et al. | 340/907. |
| 5539645 | July 1996 | Mandhyan et al. | 340/995. |
| 5543789 | August 1996 | Behr et al. | 340/995. |
| 5610821 | March 1997 | Gazis et al. | 340/995. |
| 5648768 | July 1997 | Bouve | 340/988. |
| 5689252 | November 1997 | Ayanoglu et al. | 340/905. |
| 5933100 | August 1999 | Golding et al. | 340/995. |

### SUMMARY OF THE INVENTION

The present invention provides a system for personalized traffic reports and route planning using dynamically updated travel information in conjunction with wireless communication devices that use systems capable of determining their position. Such a system uses static travel time data and dynamic system information in connection with street data to provide navigational information to the user of the system. Typically, GPS satellites or other triangulation techniques are used to geographically locate the users wireless communication device within the street system of the navigation system. A map of the surrounding streets can then be displayed to the user. Sometimes, such systems also include route planning information. In one embodiment, the present invention would include a route planning system which uses the travel time information to determine a route having minimum travel time, or meeting other criteria.

In conjunction with wireless communication device, in one embodiment, a application server would collect and store travel time information for the various street segments in a central database. When updated, the travel time information can be transferred from the central database to the individual user by the application server. The information is transferred to the wireless communication device. In addition to including time for traversing street segments, the database would also include times for transitions between segments. The transition times between segments would include different times for users proceeding through an intersection to a following street segment or turning onto adjoining street segments. The use of transition times can assist in more accurately reflecting travel time and determining optimum routes. Alternatively, the street segments can be defined between midpoints of blocks, which can include turns.

In addition to providing navigation assistance, the application server can request location information that can be used for adjusting the travel times in the central database. Since the application server determines the location of the wireless communication device with respect to street segments of a map database. This information can be used to update data on various street segments. This location information can be used to compute traffic flows in an area by correlating the change in location with the change in time. Once the data are collected and evaluated, it can be transferred to the central database by the application server from the same wireless communication device. The data can be collected and then transferred at periodic intervals back to the users of the system.

In a preferred embodiment the central database can then be updated using information received from the wireless communication devices. Preferably, the travel time in the central database would include a moving average having a certain number of data points or a specific time period. As traffic becomes more congested, the travel times reported by the wireless communication devices would increase, and the moving average would become greater. As traffic became less congested, the reported times would decrease and the moving average would similarly be reduced. The number of data points or time period used in producing the moving average could be varied by street segments depending upon the frequency of use of the street segment. In addition, the application server can determine a standard deviation for travel times on the street segments. The standard deviation information can be used to omit data points which appear erroneous. Data points caused by brief delays on a travel segment can also be omitted to prevent skewing of the data. Additionally, delays or blockages of a road segment could be flagged as a accident or problem in the system and that information could be passed to users of the system.

### BRIEF DESCRIPTION OF THE DRAWINGS

These and other features of the Subject Invention will be better understood in connection with the Detailed Description taken in conjunction with the Drawings of which:

FIG. 1 illustrates an embodiment of the route planning and navigation system of the present invention.

FIG. 2 represents storage of travel time information in a central database in conjunction with the system of FIG. 1.

### DETAILED DESCRIPTION

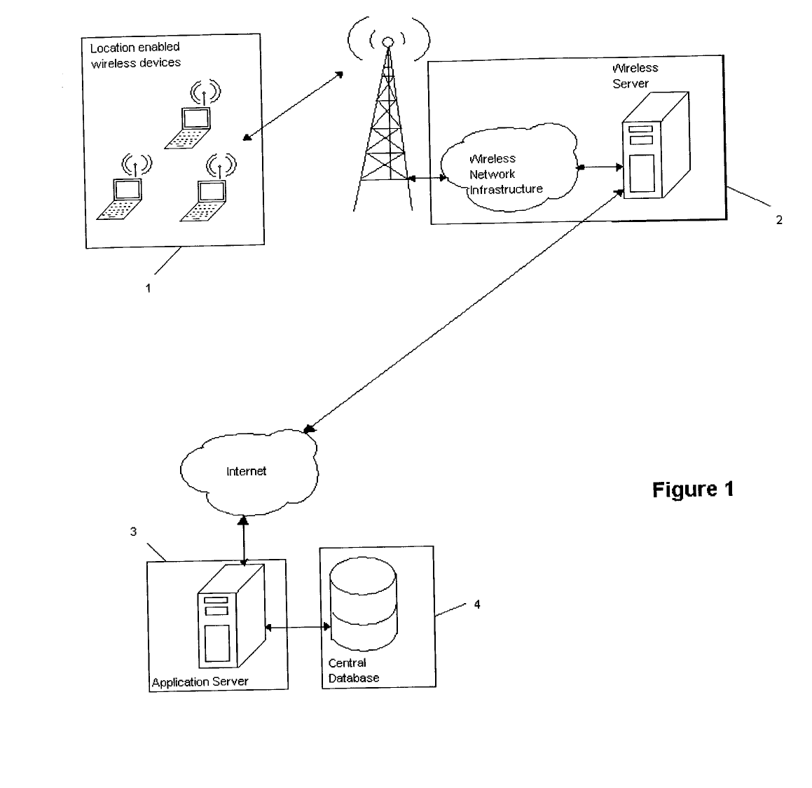

As illustrated in FIG. 1, the route planning and navigation system of the present invention includes wireless communication devices 1, a wireless network infrastructure 2, application server 3, a central database 4. The wireless communication devices 1 are located within the system. The wireless communication devices 1 include geolocation technology, which can include standard systems currently found on some wireless devices. The geolocation technology includes GPS data from satellites or other geolocation technologies that may be used in an area. The wireless communication device 1, includes a display of some form for users to view data from the application server 3. The wireless communication device 1 and the application server 3 communicate to each other over the wireless network infrastructure 2. The application server requests the location of the wireless communication devices 1, using the geolocation information, to provide data for calculating the travel time on the street segments in the central database 4. The wireless communication devices 1 can provide information to the user relating to their current position, a map of surrounding streets and routing and travel information sent from the application server 3 over the wireless network infrastructure 2. This information is sent from the application server 3 from information stored in the central database 4. The application server 3 can transmit in real time to the wireless communication device 1 travel and routing information. This information may include when turns are to be made in accordance with a particular route, traffic conditions, accident reports or other relevant travel information to the particular user.

The best route from a starting point to a destination location can be determined by the application server 3 for a specific wireless communication device 1 user. The application server 3 would analyze the central database 4 of travel time information corresponding to the street segments. The application server 3 could then obtain any additional travel time information from the central database 4, as needed. The application server 3 can process the information in the database according to one of several known factors to determine an optimal travel route from the starting to ending locations for a specific user.

As the wireless communication device 1 monitors the location of the user, it is monitored by the application server 3 for its location over time. The location of a user is sampled over time to compute the speed off a segment. In addition to street segments, the system can include representations of transitions between street segments. Transitions by users between segments can also be monitored by the application server 3 to compute times for crossing intersections or making turns. The application server 3 can then notify the wireless communication device 1 in real time to negotiate changes in their route. The route segments and travel times are stored in the central database 4, to be used to update the wireless application devices 1 by the application server3.

The application server 3 is used for dynamically updating travel time data based upon information collected from all of the wireless communication devices 1 in the navigation system. A wireless communication device 1 is used to communicate between the user and the application server 3 which then updates the central database 4 as needed to keep the rout segments data valid.

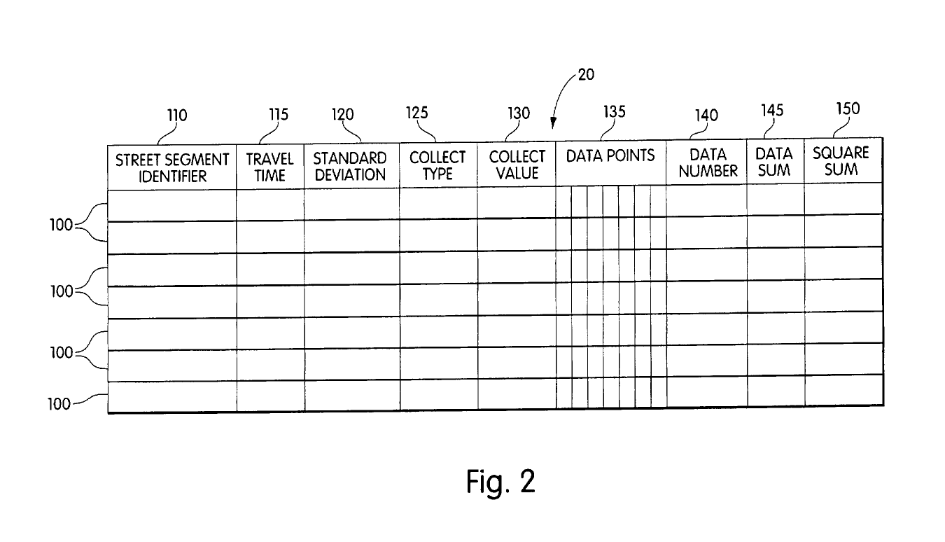

The central database 4 includes travel time data 21 The travel time data is illustrated more fully in FIG. 2. The map information is included in the central database 4, it needs to be sent to the wireless communication devices 1 from the central database 4. The central database includes street or transition segment identifiers, and travel times and map information. Associated with each street segment identifier is a determined travel time. Travel times will be determined for all types of travel routes and conditions. These travel times will be correlated to street segments, each with a separate identifier. The application server 3 determines the travel times based upon travel data received from wireless communication devices 1. The travel times in the central database 4 would be moving averages, covering a predefined time period or number of data points. Upon receiving information from a wireless communication device 1, the application server 3 would update the time calculation for the identified route segment as needed to keep the data accurate. Default data may be used when data received from the wireless communication devices 1 for a given segment is insufficient, which could occur on less traveled segments.

Numerous formulas can be used for determining the best data calculation for a street segment. These could include averaging and deviation calculations. Such data may be used to determine if a user is stopping for a short period of time on a street segment or if there is an accident or brief blockage of the street segment.

FIG. 2 illustrates a potential format for the travel time data 20 in the central database 2. Each street segment 100 would include a unique street segment identifier 110 as discussed above. The travel time 115 corresponding to the street segment would be the mean or moving average of the received data. The standard deviation 120 may also be calculated and stored. Since different processes could be used to maintain data and determine the average travel time, the type of collection 125 (whether by time or number of data points), and the amount or value of the data collection 130 (minutes of duration or number or data points) would be stored for each street segment. In order to determine a moving average, a buffer with a set of data points 135 is maintained. Various forms of sampling and averaging would be used to simplify calculations.

The application server 3 communicates with the wireless communication devices 1 to provide updated travel time information for each route segment. Various alternatives can be used for updating travel times. When planning a route, the application server 3 can contact the central database 4 to obtain updated information for the locations of interest. Alternatively, the application server 3 may periodically request location information from the wireless communication devices 1 to update travel time information in the central database 4. The application server 3 will request data from the central database 4 to be broadcast to the wireless communication devices 1 on the system. Additionally, the application server 3 can provide a proposed route to the wireless communication devices 1, when significant changes occur in travel times for street segments in the planned route of the user of the wireless communication device 1. If significant changes occur in travel times, the application server 3 may choose to re-plan a new route from the current location to the destination in order to avoid any traffic tie-ups. A threshold for improvement in estimated times should be used in determining when to make changes in a route. Otherwise, changes in routes could become confusing to the operator.

In addition to routing information, the wireless communication devices 1 could request the application server 3 for additional information including map references, routing information, directions, locations and other types of travel services that could be derived from the collected location and routing information.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention as defined by the appended claims.

All trademarks are the property of their respective owners.

What is claimed is:

1. A navigational system comprising:
a central database including:
a central memory storing a plurality of current travel times corresponding to actual travel times for wireless communication devices traversing particular street segments which are stored at the central database by an application server;
a application server including:
a application server having an input for receiving and transmitting locations, computed data, and information to the central database and an output indicating a travel route from the starting and ending locations having a minimum travel time based upon the current travel times; and
a wireless network infrastructure and internet structure for delivering data on an individual travel route to each of a plurality of wireless communication devices from the application server; and
wherein each wireless communication devices is associated with a respective one of a plurality users and comprises:
an ability to determine its position either by GPS satellite signals or other triangulation methods and determining geolocation of the wireless communication device;
an ability to send and receive data visually and audibly from the application server;

2. The navigational system of claim 1, wherein the central database includes:
a central database for storing street segments and corresponding travel time information from at least one of the wireless communication devices; and
update means for updating at least one of the plurality of current travel times based upon a received corresponding wireless communication devices location information.

3. The navigational system of claim 2, wherein the application server includes means for determining a moving average of street segments travel time from the location data from a plurality of the wireless communication devices corresponding to a single street segment.

4. The navigational system of claim 2, wherein the application server includes means for delivering real time specific information to a wireless communication device relevant to its route, travel or location.

5. The navigational system of claim 1, wherein the street segments include transition segments between two street segments.

6. The navigational system of claim 1, wherein the street segments are defined between midpoints of blocks.

8. The navigational system of claim 1, wherein the wireless communication device navigation system further includes:
wireless network communication means for providing directions to a wireless communication device regarding the travel route based upon the determined location of the wireless communication device.

9. The navigational system of claim 1, wherein the central database includes travel times for street segments and travel times for transitions between segments, wherein the travel times of transitions include times for proceeding through an intersection from one street segment to a following street segment and for turning onto adjoining street segments.

10. The navigational system of claim 6, wherein the street segments include intersections defining the blocks.

11. The navigational system of claim 1, further comprising means for computing a moving average of a number of wireless communication device locations to define an average travel time for a street segment.

13. The navigational system of claim 1, wherein the central database includes means for determining a standard deviation in the wireless communication devices travel times for each route segment.

14. The navigational system of claim 13, wherein the application server includes means for discarding a wireless communication device travel time which is significantly different from stored wireless communication devices travel times.

15. The navigational system of claim 1, wherein the application server includes means for collected data and for transferring periodically the collected data to the central database.

16. The navigational system of claim 1, wherein data derived by the system could be accessed by other users over use of the internet.
